(19) United States
(12) Patent Application Publication
(10) Pub. No.: US 2001/0016034 A1
(43) Pub. Date: Aug. 23, 2001

(54) Method and apparatus for obtaining and aggregating off-line user data for re-packaging and presentation to users over a data-packet-network

(76) Inventors: Sukhinder Singh, San Francisco, CA (US); Sreeranga Prasannakumar Rajan, Santa Clara, CA (US)

Correspondence Address: CENTRAL COAST PATENT AGENCY, PO BOX 187, AROMAS, CA, 95004, US

(21) Appl. No.: 09/757,553

(22) Filed: Jan. 9, 2001

Related U.S. Application Data
(63) Continuation-in-part of application No. 09/323,598, filed on Jun. 1, 1999, now Pat. No. 6,199,077.
Application No. 09/323,598 is a continuation-in-part of application No. 09/208,740, filed on Dec. 8, 1998.

(51) Int. Cl. G06F 15/16; H04M 1/64

(52) U.S. Cl. 379/88.17; 709/203; 709/218

(57) ABSTRACT

A data access and aggregation server for accessing and aggregating off-line message data for requesting users is provided wherein access is performed from a server location point on a data-packet-network. The data access and aggregation server comprises, at least one communication port for bi-directional data communication between the server and users accessing the server from remote access nodes having access to the network, at least one communication port for bi-directional communication between a server and remote communications systems operating on a telephone network, at least one data port for data communication between the server and a connected data repository, a processor for storing server software and communication software and a software application for enabling automated dialing and interaction with the remote communications systems. The server responding to requests from users dials destination numbers supplied by the users and upon connection therewith inputs any access codes required to trigger data playback whereupon the server records the played data and renders the data available to the requesting users. In some aspects the system also inputs access codes designed to trigger playback of message data at off-line systems.

### CROSS-REFERENCE TO RELATED DOCUMENTS

The present invention is a continuation in part (CIP) to a patent application Ser. No. 09/323,598 entitled “Method and Apparatus for Obtaining and Presenting Web Summaries to Users” filed on Jun. 01, 1999, which is a CIP to a patent application Ser. No. 09/208,740 entitled “Method and Apparatus for Providing and Maintaining a User-Interactive Portal System Accessible via Internet or other Switched-Packet-Network” filed on Dec. 08, 1998, disclosure of which is incorporated herein in its entirety herein by reference.

### FIELD OF THE INVENTION

The present invention is in the field of Internet navigation and pertains more particularly to methods and apparatus, including software, for aggregating off-line data and presenting the information in usable form to users accessing the information over a data-packet-network.

### BACKGROUND OF THE INVENTION

The information network known as the World Wide Web (WWW), which is a subset of the well-known Internet, is arguably the most complete source of publicly accessible information available. Anyone with a suitable Internet appliance such as a personal computer with a standard Internet connection may access (go on-line) and navigate to information pages (termed web pages) stored on Internet-connected servers for the purpose of garnering information and initiating transactions with hosts of such servers and pages.

Many companies offer various subscription services accessible via the Internet. For example, many people now do their banking, stock trading, shopping, and so forth from the comfort of their own homes via Internet access. Typically, a user, through subscription, has access to personalized and secure WEB pages for such functions. By typing in a user name and a password or other personal identification code, a user may obtain information, initiate transactions, buy stock, and accomplish a myriad of other tasks.

One problem that is encountered by an individual who has several or many such subscriptions to Internet-brokered services is that there are invariably many passwords and/or log-in codes to be used. Often a same password or code cannot be used for every service, as the password or code may already be taken by another user. A user may not wish to supply a code unique to the user such as perhaps a social security number because of security issues, including quality of security, that may vary from service to service. Additionally, many users at their own volition may choose different passwords for different sites so as to have increased security, which in fact also increases the number of passwords a user may have.

Another issue that can plague a user who has many passworded subscriptions is the fact that they must bookmark many WEB pages in a computer cache so that they may quickly find and access the various services. For example, in order to reserve and pay for airline travel, a user must connect to the Internet, go to his/her book-marks file and select an airline page. The user then has to enter a user name and password, and follow on-screen instructions once the page is delivered. If the user wishes to purchase tickets from the WEB site, and wishes to transfer funds from an on-line banking service, the user must also look for and select the personal bank or account page to initiate a funds transfer for the tickets. Different user names and passwords may be required to access these other pages, and things get quite complicated.

Although this preceding example is merely exemplary, it is generally known that much work related to finding WEB pages, logging in with passwords, and the like is required to successfully do business on the WEB.

A service known to the inventor provides a WEB service that allows a user to store all of his password protected pages in one location such that browsing and garnering information from them is much simplified. A feature of the above service allows a user to program certain tasks into the system such that requested tasks are executed by an agent (software) based on user instruction. The service stores user password and login information and uses the information to login to the user's online sites, thus enabling the user to navigate without having to manually input log-in or password codes to gain access to the links.

The system described above includes further enhancements taught in reference Ser. No. 09/323,598 listed above in the cross-reference section. The enhanced portal server includes a software agent configured to do summary searches for subscribers based on Internet destinations provided by the subscribers. The software agent can retrieve information from such destinations based on pre-programmed site information and can download the summary information to the subscriber. The destinations and the nature of the information to be retrieved is pre-programmed. There is further a configuration and initiation interface for a subscriber to set up and start a summary search. In some cases the summary searches are configured for individual clients as templates stored and retrieved at the Internet-connected server. Also in some cases retrieved information is immediately sent to the subscriber, and in other situations such information is saved at the portal to be retrieved by a subscriber at a later time. In preferred embodiments of the invention auto logins are accomplished for a subscriber at Internet destinations by use of pre-stored configuration information.

It has occurred to the inventor that a user may in some instances desire to obtain certain off-line information through a single interface such as the portal server described above. Examples of such off-line data may include telephone messages, voice mail messages, pager messages, message service messages and so on.

In current art, users having many off-line message locations must call each location in order to retrieve all of their messages. Recent innovation in the field of telephony has produced a capability of bridging connection-oriented-switched-telephony (COST) networks to data-packet-networks supporting IP telephony for the purpose of propagating telephony communication events between the disparate networks, the events sourced from either type of network. This enables a user having the appropriate software and a network-connected computer to dial off-line systems in order to retrieve messages. Still, the user must dial all of the disparate numbers connected to all of his or her services.

What is clearly needed is a system for retrieving off-line messages and other data from disparate services and message locations on behalf of a user such that the user may obtain all of the information through a single interface in one transaction. Such a system would greatly simplify message retrieval for a user having more than one disparate message location held off-line.

### SUMMARY OF THE INVENTION

In a preferred embodiment of the present invention, a data access and aggregation server for accessing and aggregating off-line message data for requesting users, wherein data access is performed from a server location point on a data-packet-network is provided. The data access and aggregation server comprises, at least one communication port for bi-directional data communication between the server and users accessing the server from remote access nodes having access to the network, at least one communication port for bi-directional communication between a server and remote communications systems operating on a telephone network, at least one data port for data communication between the server and a connected data repository, a processor for storing server software and communication software and a software application for enabling automated dialing and interaction with the remote communications systems. The server responding to requests from users, dials destination numbers supplied by the users and upon connection therewith, inputs any access codes required to trigger data playback whereupon the server records the played data and renders the data available to the requesting users.

In a preferred embodiment the data access and aggregation server resides on the Internet network. In this aspect, the location point is a server address on the Internet network. In a preferred embodiment, the communication between the server and users is hyper-text-transfer-protocol (HTTP) and the interface media is hyper-text-markup-language (HTML). Also in a preferred embodiment, the software application is distributed in part on the server and in part on the accessing devices of the requesting users. In an alternative embodiment, the software application is hosted in its entirety on the server. In a preferred embodiment, the accessed data comprises voice messages personalized to a requesting user. Also in a preferred embodiment, the accessed data further comprises voice messages that are accessible to the public. The accessed data is accessed from the communications systems. In this aspect, the communications systems are accessible through a telephone network. Also, in this aspect, the telephone network is the public-switched-telephony-network. In preferred embodiments, the communications systems include answering machines, answering services, voice mail services, and pager voice mail services. Also in preferred embodiments, the communications systems further include, emergency information systems, traffic alert systems, weather alert systems, and movie information systems.

In one aspect, after data access and recording, the resulting data is rendered in the form of digital voice files downloadable over the Internet. In another aspect, the resulting data is rendered in the form of digital text data. In this aspect, the digital text data is rendered in the form of text summaries.

In another aspect of the present invention, a network-based system for collecting, aggregating, and rendering off-line data for users having access to the network is provided. The system comprises, a server node connected to the network, the server node having outbound dialing capability to connection-oriented-switched-telephony numbers and interaction capability with automated systems associated with the telephony numbers, a data repository accessible to the server node, the data repository for storing information about users including telephone numbers and access codes, a network bridging facility for bridging the network of the server node to the network providing access to the connection-oriented-switched-telephone numbers and associated automated systems, a telephone routing and switching facility for routing and connecting calls initiated from the server to individual ones of the automated systems associated with individual ones of the connection-oriented-switched-telephone numbers and a plurality of user nodes having access to the network of the server. The user nodes function as requestors and receivers of the off-line data collection, aggregation and rendering services provided by the server node. The server node acting upon user request, initiates and conducts telephone calls through the network bridging facility and the telephone routing and switching facility to the automated systems associated with the connection-oriented-switched-telephone numbers for the purpose of accessing and recording message data. The message data is then rendered available to the requesting users through personalized interfaces operable through the user nodes.

In a preferred embodiment, the network is formed of a data-packet-network, a telephone network, and a wireless communications network. In preferred aspects, the data-packet-network is the Internet network, the telephone network is the public-switched-telephony-network and the wireless communications network is a cellular network servicing cellular telephones and paging systems. In one aspect, the user nodes are personal computers having connection to the Internet network and having access to the server node. In another aspect, the user nodes further include Internet-capable telephones having connection to the Internet network and having access to the server node. In still another aspect, the user nodes further include Internet-capable hand-held computers having connection to the Internet network and having access to the server node.

In one aspect of the system, the automated systems serve voice data and include answering machines, answering services, voice mail services, and pager voice mail services. In another aspect, the automated systems further include, emergency information systems, traffic alert systems, whether alert systems, and movie information systems.

In another aspect of the present invention, a method for collecting, aggregating, and rendering off-line data for requesting users operating on a data-packet-network is provided. The method comprises the steps of, (a) receiving a user request, the request sent from a user operating a user node having network access to a service-providing node operating on the data-packet-network, (b) identifying at least one telephone number identified in the request, the telephone number addressing an off-line data source, (c) dialing identified telephone number and establishing a telephony connection to the off-line data source, (d) retrieving the off-line data through automated telephone interaction, (e) recording playback of the off-line data and storing the recorded data and (f) rendering the recorded data in a form downloadable to the user node.

In a preferred embodiment, the method is practiced on the Internet network. In one aspect of the method in step (a) the user node is a personal computer and the service-providing node is a file server with outbound dialing capability. In another aspect of the method in step (a), the personal computer and the file server communicate using Internet protocol. In yet another aspect of the method in step (a), the user node is an Internet-capable cellular telephone. In still another aspect of the method in step (a), the user node is an Internet-capable hand-held computer.

In a preferred aspect of the above method, the off-line data includes voice data from one or a combination of answering machines, answering services, voice mail services, and pager voice mail services. Also in a preferred embodiment, the off-line data further includes voice data from one or a combination of emergency information systems, traffic alert systems, whether alert systems, and movie information systems.

In one aspect of the method in step (b), an access code identification is performed associating a data-access code with the appropriate telephone number identified in the request. In another aspect of the method in step (d), automated telephone interaction includes automated input of the data-access code for triggering playback of data. In some aspects of the method, in step (d), determination of input of the data-access code for triggering playback of data is accomplished by voice recognition software responding to an interactive-voice-response system. In still another aspect of the method, in step (d), determination of input of the data access code for triggering playback of data is accomplished by consultation a pre-configured interaction rules associated with the telephone number. In one aspect of the method in step (e), the recorded data is stored as a digital voice file. In this aspect, the voice file is a WAV file.

Now, for the first time, a system for retrieving off-line messages and other data from disparate services and message locations on behalf of a user is provided such that the user may obtain all of the information through a single interface in one transaction. Such a system greatly simplifies message retrieval for a user having more than one disparate message location held off-line.

### BRIEF DESCRIPTION OF THE DRAWING FIGURES

FIG. 1 is an architectural overview of a communication network wherein off-line data is retrieved, aggregated, and rendered available to users according to an embodiment of the present invention.

FIG. 2 is a block diagram illustrating off-line data aggregation application of FIG. 1 according to an embodiment of the present invention

FIG. 3 is a process flow diagram illustrating user and system steps for practicing the present invention according to an embodiment of the present invention.

### DESCRIPTION OF THE PREFERRED EMBODIMENTS

According to a preferred embodiment of the present invention, the inventor provides a network-based system for obtaining and aggregating off-line data pertinent to users and makes the data available to such users in a usable form accessible through a single interface connected to the network. The method and apparatus of the present invention is practiced in various embodiments and is described in enabling detail below.

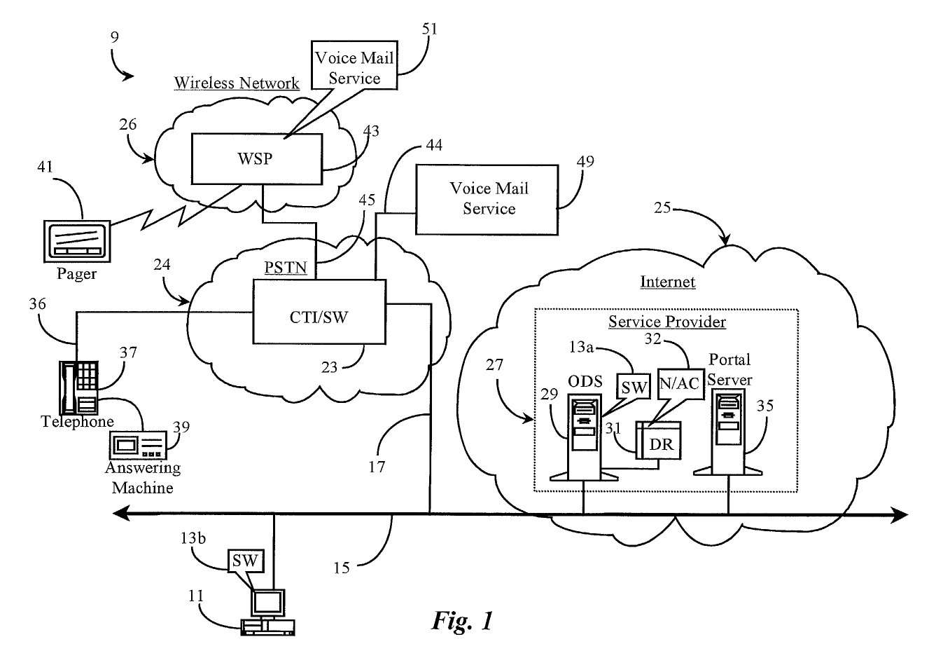

FIG. 1 is an architectural overview of a communication network 9 wherein off-line data is retrieved, aggregated, and rendered available to users according to an embodiment of the present invention. Communication network 9 comprises three separate and disparate but participatory networks. A data-packet-network 25, which is the Internet network in this example and hereinafter referred to as Internet 25, is illustrated as one of the three participatory networks. A telephony network 24, which is a well-known public-switched-telephony-network (PSTN) in this example and hereinafter referred to as PSTN 24 is illustrated as another. A cellular network 26 is illustrated as the third participatory network in this embodiment.

It should be understood that networks 26, 25, and 24 are exemplary, and not limiting to the invention. For example, Internet 25 may be instead a wide-area-network (WAN), either corporate or private. PSTN 24 may instead be a private telephony network. Wireless network 26 may be any type of wireless communication network using cellular, or other wireless communications technologies. The inventor chooses networks 25-26 in combination to form communication network 9 as a preferred example of a communications network wherein the present invention may be practiced. Internet network 25 is further exemplified by an Internet backbone 15 illustrated herein as extending therethrough. Backbone 15 represents all of the lines, equipment, and connection points making up the Internet network as a whole including any sub-networks connected thereto. Therefore there are no geographic limitations to the practice of the present invention. Similarly speaking, PSTN 24 represents all the lines connection points and equipment making up the PSTN network as a whole including other accessible telephony networks that may be connected thereto. Wireless network 26 represents all accessible cellular areas or other wireless communications boundaries accessible through PSTN 24.

A service provider 27 is illustrated within Internet 25 and adapted to provide data-aggregation and summary services to users as described in cross-referenced document Ser. No. 09/323,598. However, this specification will focus on a novel capability of providing a service wherein off-line data may be accessed, aggregated, and presented to users. In this example a portal server 35 is provided within service provider 27 and connected to backbone 15. Server 35 is adapted as a user-interfacing server for providing access to services offered by provider 27 including aggregation of off-line data.

Server 35 serves electronic information pages, known as Web pages in the art, to requesting users accessing the server over backbone 15. An example of such a user is exemplified in this embodiment by a PC icon 11 illustrated as connected to backbone 15 by an Internet-access line 12. PC 11 represents any user's computer equipment capable of accessing server 35 through Internet backbone 15. It may be assumed in this example that PC 11 accesses server 35 by way of normal Internet connectivity means such as may be known in the art. Examples of possible Internet connection schemes include dial-up modem connection through an Internet-service-provider (ISP) through PSTN 24, an integrated- services-digital-network (ISDN) line or digital-subscriber-line (DSL), cable/modem technology, and through various wireless connection technologies. There are many variant connection-architectures possible in the art, therefore Internet access line 12 is intended solely to logically represent an Internet connection.

Portal server 35 is adapted to serve personalized portal pages to requesting users as described in both cross-referenced documents Ser. No. 09/208,740 and Ser. No. 09/323,598, wherein interactive input mechanisms are provided for ordering various data summarization services. In this example, users may access portal server 35 for the purpose of ordering a data summary representing a compilation of off-line data messages held at various off-line locations. The term off-line as used in this specification refers to any user-subscribed data sources that are accessible by telephone or other communication mode, but do not have an Internet presence. Such data may represent standard telephone messages, cellular phone messages, pager messages, voice mail messages, and any other types of recorded, typically electronic entities that may be normally accessible by dialing a connection-oriented-switched-telephony (COST) telephone number.

An outbound dialing server (ODS) 29 is provided within service provider 27 and illustrated as connected to Internet backbone 15. ODS 29 is adapted as an automated outbound dialing system capable of accessing COST telephone numbers. A data repository (DR) 31 is provided and illustrated as connected to ODS 29 by virtue of a high-speed data link. Data repository 31 is adapted to hold profile and practical data about users who subscribe to on-line and off-line data aggregation services provided by service provider 27. Examples of the types of data held in repository 31 include, but are not limited to, contact information, identification information, account information, and certain profile data.

An instance of software (SW) 13(b, a) is provided as a client/server application with one part distributed to ODS 29 (13a) and another part distributed to PC 11 (13b). SW 13b at PC 11 may, in one embodiment, be a browser plug-in adapted to communicate data to SW 13a running on ODS 29. In this case, portal server 35 simply redirects users to server 29 for requested off-line data aggregation services. Re-direction may be accomplished by hyper-linking from a personal interface served by server 35 to an electronic interface (not shown) provided in server 29. It is noted herein, that data repository 31 contains, in addition to user identification and contact parameters, user supplied telephone numbers and access codes (N/AC 32) for enabling server 29 to obtain associated off-line message data using outbound dialing technology.

Off-line message data for a user is illustrated as available from a variety of sources illustrated in this embodiment. Wireless network 26 contains a wireless service provider (WSP) 43. WSP 43 provides wireless services to users operating wireless communications devices. One such device illustrated in this embodiment is a pager 41. Pager 41 is a two-way pager in this example. WSP 43 may also provide services to other types of devices such as a cellular telephone or a fixed wireless telephone. In this example, WSP provides a voice mail service 51 enabling a user of pager 41 to retrieve voice mails held at the service location.

A computer-telephony-integrated switch (CTI/SW) 23 is illustrated within PSTN 24 and adapted as a telephone call routing and switching point within the network. CTI/SW 23 may be any type of telephony switch known in the art such as an automatic call distributor (ACD), or other known equipment. Off-line message locations accessible through CTI/SW 23 include an illustrated telephone 37 connected to an answering machine 39. Telephone 37 is connected to CTI/SW 23 by way of a telephone line 36. Answering machine 39 is adapted to hold voice messages left for a user or users of telephone 37. A voice message service 49 is illustrated in this example and represents an entity providing a voice mail service for users. Service 49 is connected to switch 23 by virtue of telephony trunk 44. An example of service 49 would be that of a live-operator answering service for a business. It is noted herein that CTI/SW 23 is connected to WSP 43 by a telephony trunk 45. Therefore, all of the off-line data sources illustrated in this embodiment are accessible in this example through PSTN 24 and a CTI/SW 23. In another embodiment, disparate off-line data sources may be accessible by varied network paths and not necessarily through a single network switch (23).

CTI/SW 23 is connected to Internet backbone 15 by a network access line 17. It is noted herein but not illustrated that a network gateway adapted for bridging PSTN 24 to Internet 25 is assumed to be present somewhere along network access line 17 in order to enable cross communication between the networks. Such capability is known the art and described in the background section.

It is assumed in this example that a user operating PC 11 is a same user identified as a receiver of off-line message data held in answering machine 3 9, at voice message service 49, and at WSP 43 by virtue of voice mail service 51. In a prior-art scenario, the user operating PC 11 must either through PC 11 and an IP phone software, or through a telephone (not shown), dial-up each telephone number associated with each off-line message source and enter appropriate access codes by touch tone or voice means in order to remotely retrieve his or her messages.

In practice of the present invention, a user operating PC 11 accesses portal server 35 via an Internet-access technology as described above, and receives a personal portal page. By invoking a hyperlink provided within the served portal page, the off-line data aggregation service of the present invention hosted, in this example, within server 29 is accessed. Server 29 is now the interfacing server communicating with PC 11. Once connected to ODS 29, a request may be initiated from PC 11 for collection, aggregation, and presentation of off-line data. Upon receiving a request from a user operating PC 11, ODS 29 accesses data repository 31 to obtain the appropriate telephone numbers and access codes (32) that will be used to enable processing of the request. ODS 29, by virtue of SW 13a, places outbound calls to the appropriate telephone numbers associated with the off-line data sources. Once connected to a telephone number representing an off-line data source, the appropriate access code is used to invoke audio playback of stored messages. A recording function (not shown) attributed to SW 13a records message data during playback and stores the data on behalf of the requesting user in data repository 31. After a request is completely processed, the requesting user may access all off-line messages through a single interface during the same transaction. Aggregated message data may be temporarily held in data repository 31 or in any other connected repository accessible to ODS 29 for to portal server 35.

In one embodiment of the present invention request for retrieving off-line data and rendering it available may be real-time requests wherein the process is conducted while the requesting user is still in session (PC 11 to ODS 29) as described above. In another embodiment of the present invention requests may be pre-configured to execute on a periodic basis whether or not the requesting user is physically connected to the service. In the latter case, a user operating PC 11 may be notified of available messages at the time of login to portal server 35.

Rendering of off-line data into a form that may be transmitted to PC 11 may be accomplished using analog to digital conversion technologies. Voice data can, for example, be obtained and converted into a .WAV or other known digital file format that is downloadable to PC 11. In one embodiment, voice messages, whether analog or digital, may be recorded and converted to text messages using voice to text software. There are many possibilities. The service of the present invention enables a user operating PC 11 or another Internet-capable device to retrieve off-line data from disparate sources through a single user interface during one transaction.

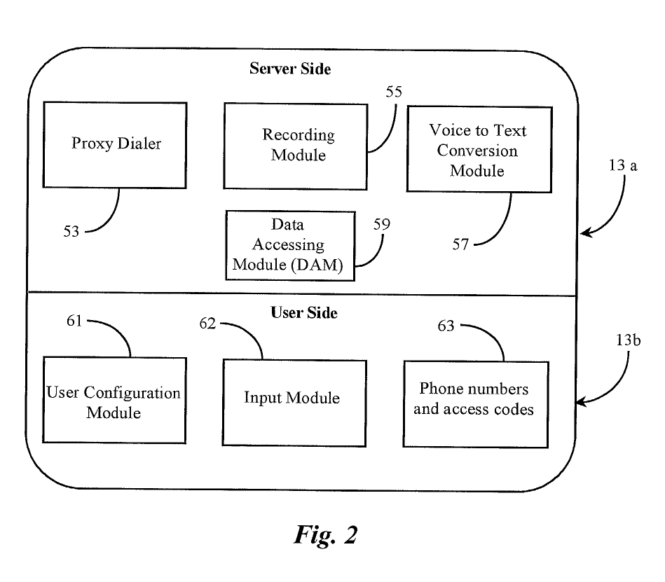

FIG. 2 is a block diagram illustrating off-line data aggregation application 13(a, b) of FIG. 1 according to an embodiment of the present invention. Server side application 13a, illustrated as executing on server 29 of FIG. 1 above, comprises a plurality of functional modules in this embodiment. A proxy dialer 53 is provided within application 13a and represents an IP telephone application capable of automated outbound dialing using user-supplied telephone numbers as data input. Proxy dialer 53 may also include a function enabling automated interaction with an interactive-voice-response (IVR) system. For example, after dialing a number and connecting to the associated destination, voice recognition software may be utilized to understand IVR instruction regarding entering an access code in order to retrieve specific messages. In some embodiments, an appropriate access code for retrieving messages is automatically entered by proxy dialer 53 after connecting to a destination service. In other embodiments dialer 53 may wait for an IVR voice prompt before entering a code. These types of parameters or rules-for-access may be preprogrammed with specific telephone numbers and access codes supplied by users.

SW 13a accesses telephone numbers and access codes from data repository 31 described in FIG. 1. A data-accessing module (DAM) 59 is provided for this purpose. A single user request may embody one, more than one, or all of the user's telephone numbers and access codes. In a real time service embodiment, SW 13a accesses only the required numbers and access codes to fill a particular request. It is assumed that in a periodic service environment that all provided numbers and access codes would be utilized during a data-retrieval and store scenario that would be performed perhaps once per day on behalf of all requesting users. However any combination of services may be configured by a requesting user.

A recording module 55 is provided within SW 13a and adapted to record voice messages as they are played during connection with a data source. Module 55 may be programmed to start and stop based on instruction from proxy dialer 53. Recording module 55 may record according to any desired digital format known the art. A voiced to text conversion module 57 is provided as an optional module within SW 13a. Module 57 uses voice to text technology to convert a record voice message into a text message.

User-side application 13b, illustrated on PC 11 of FIG. 1 provides a user configuration interface for pre-configuring parameters and communicating and updating telephone numbers and access codes. A user configuration module 61 is provided to enable a user to input telephone numbers and access codes for destinations having message data for access as well as to input known rules for accessing data. Module 61 also enables a user to pre-configure requests designed to be executed periodically. An input module 62 enables a user to configure real-time requests to be executed while a user is connected in session with ODS 29 of FIG. 1. A module 63 is provided for keeping a current user list of telephone numbers and access codes stored in user cache. Communication modules (none shown) may be assumed to be present for enabling data communication between application 13a and 13b.

In one embodiment of the present invention, SW applications 13a and 13b are provided as a single application running on ODS 29 of FIG. 1. In another embodiment, the software may be provided on any other server designated as an interfacing server. The method of user interface is in preferred embodiments, an HTML interface displayable on such as PC 11, however other technologies may be employed for other types of access devices. For example, a scaled-down version (Web clipping) of interfacing media may be provided for Web-enabled cell phones, hand-held computers, and other Internet-capable accessing devices.

In addition to access and aggregation of personalized message data, the method and apparatus of the present invention may be used to access and aggregate publicly accessible data. Examples include but are not limited to recorded movie listings, traffic and weather alerts, emergency instruction data, and virtually any other type of recorded data accessible by telephone.

It will be apparent to one with skill in the art, that there may be more software modules illustrated in application 13(a, b) than are illustrated in this example without departing from the spirit and scope of the present invention. For example, application program interface (API) modules may exist for interfacing with supporting software programs providing functions such as voice recognition, voiced to text conversion, instruction software containing access an interaction rules for dialing and interacting with destination equipment, and so on.

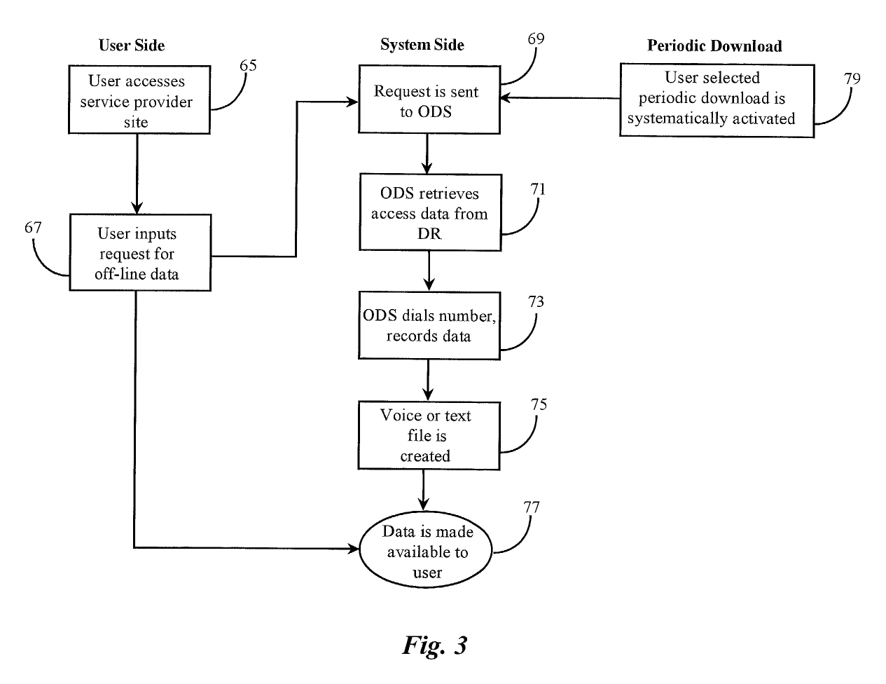

FIG. 3 is a process flow diagram illustrating user and system steps for practicing the present invention according to an embodiment of the present invention. At step 65, a user accesses a web site maintained by a service provider, which is accomplished in the example illustrated in FIG. 1 by first accessing portal server 35 and being redirected to outbound dialing system and server 29. It is noted herein that access may be accomplished using any Internet-capable device having sufficient input functionality and display means. At step 67, the requesting user inputs information forming a data request for receiving off-line data. Step 67 represents an example wherein the requesting user initiates a sequence while physically connected to the providing server (ODS 29).

In an embodiment wherein the off-line data is systematically aggregated, steps 79 illustrated under the heading periodic download, is performed on an ongoing basis at a frequency determined by the service provider. In this case at any pre-configured time steps 69-77 are automatically executed as a sequence using data pre-supplied by the requesting user. Such a sequence occurs in the background and is transparent to requesting user. If at step 67, the requesting user desires to initiate an impromptu sequence or “refresh”, then at step 69 the requested sent to the outbound dialing server illustrated in FIG. 1 has ODS 29.

At step 71, the outbound dialing server retrieves access data comprising telephone numbers and access codes identified in request of step 67 from a connected data repository illustrated in FIG. 1 as DR 31. At step 73, the outbound dialing server begins a sequence of automated dialing, connection, entry of access code, and recording of message data. Step 73 is repeated as a process for each access telephone number identified in a single request. At step 75, voice or text versions of the recorded data are formatted for presentation to the requesting user. Voice data may be reformatted according to a WAV format or other known digital formats. Optionally, text renditions of the recorded data may be provided using suitable voice to text software. In the latter case, text versions of recorded messages may only be summaries of the content contained in each represented message. At step 77, the formatted data is made available to the requesting user in the form of a download that may be presented according to a push or pull scenario based on the desire of the requesting user.

It will be apparent to one with skill in the art that the user and system process steps illustrated in this example represent just one of a variety of possible sequences that may be employed and implemented for practicing the present invention. Other steps to be included in an automated sequence according to variant embodiments of the invention. For example, in one embodiment step 75 would not be required to access device is capable of playing digital voice files. In another embodiment, data obtained aggregated and formatted for a user may be delivered to a node or access device other than the one initiating a request. There are many variant possibilities.

The method and apparatus of the present invention may be practiced on any data-packet-network that may be bridged to any telephone network having routed access to the destination numbers of a request. Therefore, the method and apparatus of the present invention should be afforded the broadest scope under examination. The spirit and scope of the present invention is limited only by the claims that follow.

What is claimed is:

1. A data access and aggregation server for accessing and aggregating off-line message data for requesting users, access performed from a server location point on a data-packet-network comprising:
at least one communication port for bi-directional data communication between the server and users accessing the server from remote access nodes having access to the network;
at least one communication port for bi-directional communication between a server and remote communications systems operating on a telephone network;
at least one data port for data communication between the server and a connected data repository;
a processor for storing server software and communication software; and,
a software application for enabling automated dialing and interaction with the remote communications systems, characterized in that the server responding to requests from users dials destination numbers supplied by the users and upon connection therewith inputs any access codes required to trigger data playback whereupon the server records the played data and renders the data available to the requesting users.

2. The data access and aggregation server of claim 1, wherein the data-packet-network is the Internet network.

3. The data access and aggregation server of claim 2, wherein the location point is a server address on the Internet network.

4. The data access and aggregation server of claim 3, wherein the communication between the server and users is hyper-text-transfer-protocol and the interface media is hyper-text-markup-language.

5. The data access and aggregation server of claim 4, wherein the software application is distributed in part on the server and in part on the accessing devices of the requesting users.

6. The data access and aggregation server of claim 4, wherein the software application is hosted in its entirety on the server.

7. The data access and aggregation server of claim 5, wherein the accessed data comprises voice messages personalized to a requesting user.

8. The data access and aggregation server of claim 7, wherein the accessed data further comprises voice messages that are accessible to the public.

9. The data access and aggregation server of claim 8, wherein the accessed data is accessed from the communications systems, the communications systems accessible through a telephone network.

10. The data access and aggregation server of claim 9, wherein the telephone network is the public-switched-telephony-network.

11. The data access aggregation server of claim 10, wherein the communications systems include answering machines, answering services, voice mail services, and pager voice mail services.

12. The data access and aggregation server of claim 11, wherein the communications systems further include, emergency information systems, traffic alert systems, weather alert systems, and movie information systems.

13. The data access and aggregation server of claim 12, wherein after data access and recording, the resulting data is rendered in the form of digital voice files downloadable over the Internet.

14. The data access and aggregation server of claim 12, wherein after data access and recording, the resulting data is rendered in the form of digital text data.

15. The data access and aggregation server of claim 14, wherein the digital text data is of the form of text summaries.

16. A network-based system for collecting, aggregating, and rendering off-line data for users having access to the network comprising:
a server node connected to the network, the server node having outbound dialing capability to connection-oriented-switched-telephony numbers and interaction capability with automated systems associated with the telephony numbers;
a data repository accessible to the server node, the data repository for storing information about users including telephone numbers and access codes;
a network bridging facility for bridging the network of the server node to the network providing access to the connection-oriented-switched-telephone numbers and associated automated systems;
a telephone routing and switching facility for routing and connecting calls initiated from the server to individual ones of the automated systems associated with individual ones of the connection-oriented-switched-telephone numbers; and
a plurality of user nodes having access to the network of the server, the user nodes functioning as requestors and receivers of the off-line data collection, aggregation and rendering services provided by the server node, wherein the server node acting upon user request initiates and conducts telephone calls through the network bridging facility and the telephone routing and switching facility to the automated systems associated with the connection-oriented-switched-telephone numbers for the purpose of accessing and recording message data, the message data rendered available to the requesting users through personalized interfaces operable through the user nodes.

17. The network-based system of claim 16, wherein the network is formed of a data-packet-network, a telephone network, and a wireless communications network.

18. The network-based system of claim 17, wherein the data-packet-network is the Internet network.

19. The network-based system of claim 18, wherein the telephone network is the public-switched-telephony-network.

20. The network-based system of claim 19, wherein the wireless communications network is a cellular network servicing cellular telephones and paging systems.

21. The network-based system of claim 20, wherein the user nodes are personal computers having connection to the Internet network and having access to the server node.

22. The network-based system of claim 21, wherein the user nodes further include Internet-capable telephones having connection to the Internet network and having access to the server node.

23. The network-based system of claim 22, or in the user nodes further include Internet-capable hand-held computers having connection to the Internet network and having access to the server node.

24. The network-based system of claim 23, wherein the automated systems serve voice data and include answering machines, answering services, voice mail services, and pager voice mail services.

25. The network-based system of claim 24, wherein the automated systems further include, emergency information systems, traffic alert systems, whether alert systems, and movie information systems.

26. A method for collecting, aggregating, and rendering off-line data for requesting users operating on a data-packet-network comprising steps of:
(a) receiving a user request, the request sent from a user operating a user node having network access to a service-providing node operating on the data-packet-network;
(b) identifying at least one telephone number identified in the request, the telephone number addressing an off-line data source;
(c) dialing identified telephone number and establishing a telephony connection to the off-line data source;
(d) retrieving the off-line data through automated telephone interaction;
(e) recording playback of the off-line data and storing the recorded data; and
(f) rendering the recorded data in a form downloadable to the user node.

27. The method of claim 26, wherein the data-packet-network is the Internet network.

28. The method of claim 27 wherein in step (a) the user node is a personal computer and the service-providing node is a file server with outbound dialing capability.

29. The method of claim 28 wherein in step (a), the personal computer and a file server communicate using Internet protocol.

30. The method of claim 28 wherein in step (a), the user node is an Internet-capable cellular telephone.

31. The method of claim 28 wherein in step (a), the user node is an Internet-capable hand-held computer.

32. The method of claim 27, wherein the off-line data includes voice data from one or a combination of answering machines, answering services, voice mail services, and pager voice mail services.

33. The method of claim 32, wherein the off-line data further includes voice data from one or a combination of emergency information systems, traffic alert systems, whether alert systems, and movie information systems.

34. The method of claim 33 wherein in step (b), an access code identification is performed associating a data-access code with the appropriate telephone number identified in the request.

35. The method of claim 34 wherein in step (d), automated telephone interaction includes automated input of the data-access code for triggering playback of data.

36. The method of claim 35 wherein in step (d), determination of input of the data-access code for triggering playback of data is accomplished by voice recognition software responding to an interactive-voice-response system.

37. The method of claim 35 wherein in step (d), determination of input of the data access code for triggering playback of data is accomplished by consultation a pre-configured interaction rules associated with the telephone number.

38. The method of claim 33 wherein in step (e), the recorded data is stored has a digital voice file.

39. The method of claim 38 wherein in step (e), the voice file is a WAV file.
